(19) United States
(12) Patent Application Publication
(10) Pub. No.: US 2026/0329082 A1
(43) Pub. Date: Oct. 22, 2026

(54) METHODS AND SYSTEMS FOR ENHANCING USER FOCUS WHILE USING AUGMENTED-REALITY GLASSES

(71) Applicant: Samsung Electronics Co., Ltd., Suwon-si (KR)

(72) Inventors: Jersha FELIX, Tamil Nadu (IN); Jinwon KIM, Suwon-si (KR); Ashok GEORGE, Bengaluru (IN); Sujoy SAHA, Bengaluru (IN)

(21) Appl. No.: 19/573,296

(22) Filed: Mar. 20, 2026

Related U.S. Application Data
(63) Continuation of application No. PCT/KR2026/000343, filed on Jan. 7, 2026.

(30) Foreign Application Priority Data
Apr. 16, 2025 (IN) 202541036941
Jul. 31, 2025 (IN) 202541036941

(51) Int. Cl. G02B 27/01; G02B 27/00

(52) U.S. Cl. CPC G02B 27/0101; G02B 27/0093; G02B 2027/0118

(57) ABSTRACT

A method for enhancing user focus while using Augmented-Reality (AR) glasses may be provided. The method may include identifying, within a Field-of-View (FOV) of the electronic device, at least one attention region and at least one non-attention region based on a real-world activity of an user. The method may include detecting at least one distracting event in the identified at least one attention region. The method may include modifying display properties of at least a part of a display of the electronic device based on the at least one distracting event.

### CROSS-REFERENCE TO RELATED APPLICATIONS

This application is a continuation of International Application No. PCT/KR2026/000343 designating the United States, filed on Jan. 7, 2026, in the Korean Intellectual Property Receiving Office and claiming priority to Indian Provisional Patent Application No. 202541036941, filed on Apr. 16, 2025, in the Indian Patent Office, and Indian Patent Application No. 202541036941, filed on Jul. 31, 2025, in the Indian Patent Office, the disclosures of each of which are incorporated by reference herein in their entireties.

### BACKGROUND

### Field

The disclosure relates to the field of display devices and for example, to a method and system for enhancing user focus while using Head Mounted Display (HMD) devices such as Augmented-Reality (AR) glasses, and the like.

### Description of Related Art

Generally, images and videos are sources for users to consume content. The images and videos assist users in learning and understanding different types of content, for example, working on any components, concepts, etc. The video is recorded and rendered by a device, for example, a mobile, a video camera, etc. Viewing experience via display devices such as a mobile phone, laptop, LED display devices, and the like, is generally restricted to a 2-Dimensional (2-D) space.

A Visual See Through (VST) device is an electronic display device that allows the user to see what is shown on the screen while still being able to see through the screen. Examples of VST devices include head-up displays, augmented reality systems, and the like. The VST device may be a Head Mounted Display (HMD) device. The VST device may be mounted on a user's forehead covering the eyes of the user. The VST device includes a display screen (digital screen) between the real world and the eyes of the user. The screen is a see-through screen and is typically placed very close to the eyes of the user.

### SUMMARY

According to an embodiment of the disclosure, the disclosure provides a method performed by an electronic device. The method may include identifying, within a Field-of-View (FOV) of the electronic device, at least one attention region and at least one non-attention region based on a real-world activity of an user. The method may include detecting at least one distracting event in the identified at least one attention region. The method may include modifying display properties of at least a part of a display of the electronic device based on the at least one distracting event.

According to an embodiment of the disclosure, the disclosure provides an electronic device. The electronic device may include memory storing instructions. The electronic device may include at least one processor operatively coupled to the memory and comprising processing circuitry. The at least one processor individually or collectively executes the instructions to cause the electronic device to identify within a Field-of-View (FOV) of the electronic device, at least one attention region and at least one non-attention region based one a real-world activity of an user. The at least one processor individually or collectively executes the instructions to cause the electronic device to detect at least one distracting event in the identified at least one attention region. The at least one processor individually or collectively executes the instructions to cause the electronic device to modify display properties of at least a part of a display of the electronic device based one the at least one distracting event.

According to an embodiment of the disclosure, a computer-readable storage medium configured to store at least one instruction, which, when executed by at least one processor individually or collectively, may cause an electronic device to perform the method.

A more detailed description of the disclosure will be rendered with reference to various example embodiments thereof, which are illustrated in the appended drawing. It will be appreciated that these drawings merely depict example embodiments of the disclosure and are therefore not to be considered limiting its scope. The disclosure will be described and explained with additional specificity and detail with reference to the accompanying drawings.

### BRIEF DESCRIPTION OF THE DRAWINGS

These and other features, aspects, and advantages of an embodiment of the disclosure will be more apparent from the following detailed description, taken in conjunction with the accompanying drawings in which like characters represent like parts throughout the drawings, and in which:

FIG. 1 is a diagram illustrating a scenario depicting a user using a Visual See Through (VST) device while engaging in a real-world activity, according to an embodiment of the disclosure;

FIG. 2 is a diagram illustrating various scenarios depicting example issues that the user may face while using the VST device such as AR (Augmented Reality) glasses, according to an embodiment of the disclosure;

FIG. 3 is a diagram illustrating an example environment comprising a system for enhancing user focus while using a VST device such as the AR glasses during a real-world activity, according to an embodiment of the disclosure;

FIG. 4 is a diagram illustrating an example configuration of a system for enhancing the user focus while using the VST device, according to an embodiment of the disclosure;

FIG. 5A is a diagram illustrating an example process flow of the system for enhancing the user focus while using the AR glasses, according to an embodiment of the disclosure;

FIG. 5B is a diagram illustrating example working of an identification module of the system for enhancing the user focus while using the AR glasses, according to an embodiment of the disclosure;

FIG. 5C is a diagram illustrating example working of a discomfort region predicting module of the system for enhancing the user focus while using the AR glasses, according to an embodiment of the disclosure;

FIGS. 5D and 5E are diagrams illustrating example working of a modifying module of the system for enhancing the user focus while using the AR glasses, according to an embodiment of the disclosure;

FIGS. 6A and 6B are diagrams illustrating examples of one or more capturing devices of the AR glasses, according to an embodiment of the disclosure; and

FIG. 7 is a flowchart illustrating an example method for enhancing user focus while using the VST device such as AR glasses, according to an embodiment of the disclosure.

Further, one skilled in the art will appreciate that elements in the drawings are illustrated for simplicity and may not have necessarily been drawn to scale. For example, the flowcharts illustrate the method in terms of the operations illustrated in order to aid in understanding of the disclosure. Furthermore, in terms of the construction of the device, one or more components of the device may have been represented in the drawings by conventional symbols, and the drawings may show elements to aid understanding the disclosure so as not to obscure the drawings with details that will be readily apparent to those skilled in the art having the benefit of the description herein. It should be appreciated that the blocks in each flowchart and combinations of the flowcharts may be performed by one or more computer programs which include computer-executable instructions. The entirety of the one or more computer programs may be stored in a single memory or the one or more computer programs may be divided with different portions stored in different multiple memories.

### DETAILED DESCRIPTION

Reference will now be made to various example embodiments, and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

The term “some” or “one or more” as used herein is defined as “one”, “more than one”, or “all”. Accordingly, the terms “more than one”, “one or more” or “all” would all fall under the definition of “some” or “one or more”. The term “an embodiment”, “another embodiment”, “some embodiments”, or “in one or more embodiments” may refer to one embodiment or several embodiments, or all embodiments. Accordingly, the term “some embodiments” is defined as meaning “one embodiment, or more than one embodiment, or all embodiments”.

The terminology and structure employed herein are for describing, teaching, and illuminating various embodiments and their specific features and elements and do not limit, restrict, or reduce the spirit and scope of the claims or their equivalents. The phrase “exemplary” may refer to an example.

For example, any terms used herein such as but not limited to “includes”, “comprises”, “has”, “consists”, “have” and grammatical variants thereof do not specify an exact limitation or restriction and certainly do not exclude the possible addition of one or more features or elements, unless otherwise stated, and must not be taken to exclude the possible removal of one or more of the listed features and elements, unless otherwise stated with the limiting language “mush comprise” or “needs to include”.

Whether a certain feature or element was limited to being used only once, either way, it may still be referred to as “one or more features”, “one or more elements”, “at least one feature”, or “at least one element”. Furthermore, the use of the terms “one or more” or “at least one” feature or element does not preclude there being none of that feature or element unless otherwise specified by limiting language such as “there needs to be one or more ” or “one or more element is required”.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory or the one or more computer programs may be divided with different portions stored in different multiple memories.

Any of the functions or operations described herein can be processed by one processor or a combination of processors. The one processor or the combination of processors is circuitry performing processing and includes circuitry like an application processor (AP), a communication processor (CP), a graphical processing unit (GPU), a neural processing unit (NPU), a microprocessor unit (MPU), a system on chip (SoC), an IC, or the like.

Unless otherwise defined, all terms, and especially any technical and/or scientific terms, used herein may be taken to have the same meaning as commonly understood by one skilled in the art.

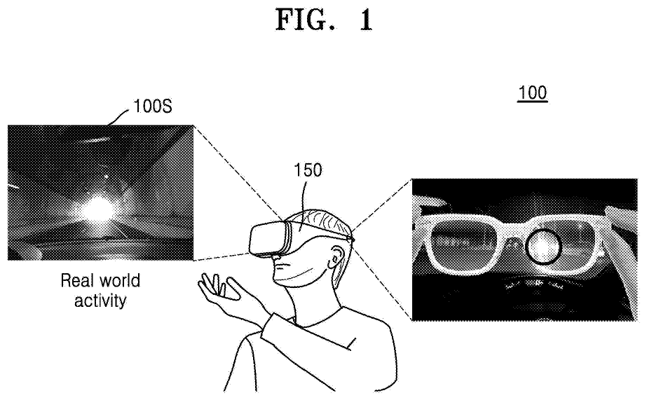

FIG. 1 is a diagram illustrating a scenario 100 depicting a user using a Visual See Through (VST) device 150 while engaging in a real-world activity, according to an embodiment of the disclosure. The real-world activity 100S may be captured in the form of images or a series of images, and the like and rendered on a screen of the device 150. The VST device 150 gives viewers a more immersive viewing experience via a pass-through mode of the VST device 150. In the pass-through mode, the user is able to see the real world in real-time while wearing the VST device 150. For realizing the pass-through mode, the VST device 150 has a display and includes a pair of cameras (depicting each eye of the pair of eyes of a human being). The two cameras capture a scene of the real-world and project the scene on the transparent display (digital screen) of the VST device 150 in real-time.

The pass-through mode of the VST device 150 may be enabled in various scenarios such as a Mixed Reality scenario. In the mixed reality scenario, the attention of the user is more focused on the virtual content. The pass-through mode may be enabled during an Augmented Reality (AR) scenario, wherein the user has his full attention on the AR content. The AR scenario is enabled by wearing a VST device such as AR glasses. However, while using AR glasses, a user may face several undesirable issues.

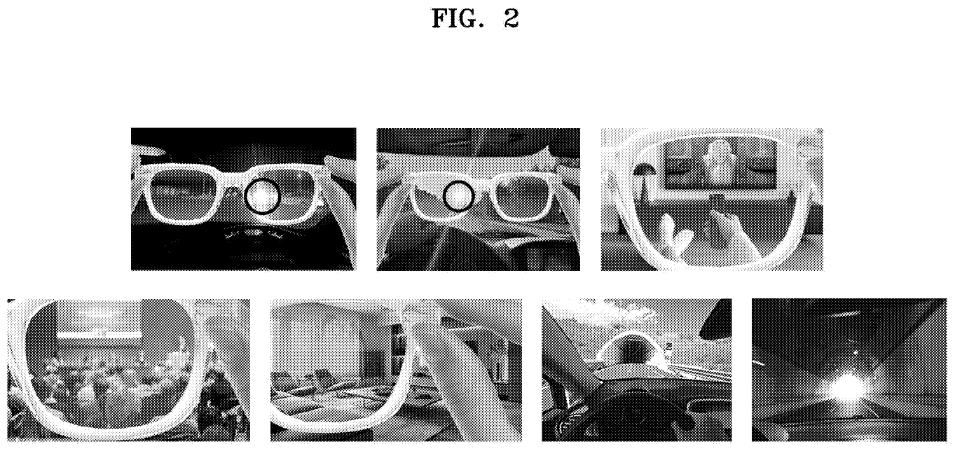

FIG. 2 is a diagram illustrating various scenarios depicting example issues that the user may face while using the AR glasses, according to an embodiment of the disclosure. For example, the user may face a visual overload, wherein the AR glasses may render an amount of visual information which may be too much for the user to comprehend making it difficult for the user to focus on other desirable tasks. This may happen when there may be too many elements in the physical environment competing for user's attention, such as busy streets, crowded spaces, or excessive visual stimuli around the user in the real-world. The AR glasses, when overlaying the additional information of the real-world tend to amplify this overload of visual information for the user, which makes the experience unpleasant and sometimes tiring for the eyes of the user at least.

Another issue with the use of the AR glasses is the distraction caused when the AR glasses render irrelevant elements form the real-world environment. As a result, the user may get distracted thereby reducing the productivity of the user while performing or engaging in the related activity in the real-world. Examples of distraction causing elements in the real-world may include bright lights, flashing lights, bright colors, moving objects, or unexpected sounds. Such elements may divert the attention of the user away from the task-at-hands associated with the real-world activities. For example, when the user is trying to concentrate on navigation directions being rendered in the AR glasses while passing through a visually noisy cityscape, the user may get distracted by the visual noises of the cityscape which may make it difficult for the user to focus on the navigation directions.

Furthermore, since the AR glass (or glasses) is designed to continually filter through both real and virtual information, it may lead to cognitive overload and increased mental strain and fatigue for the user. Both the AR glass and the physical environment may contribute to the cognitive overload. The user's brain is overloaded since it has to simultaneously interpret AR overlays and real-world elements, like analyzing navigation cues in XR while also paying attention to traffic. This dual demand can lead to mental fatigue and reduce performance.

There may be issues related to safety concerns, wherein distracting visual elements may pose safety risk especially in complex and dynamic environments such as while the user may be driving. For example, in the physical world, hazards like glare from the sun or bright headlights can obscure the vision of the user. Similarly, highly distracting elements like digital billboards or advertisement boards can divert attention while driving or walking, increasing the risk of accidents.

The issues enumerated above are some of the examples of the issues affecting the user's immersive experience while using the VST devices such as AR glasses.

Therefore, in view of the above-mentioned problems, it is desired to provide an improved system and method that can address the issues with the user's attention and focus while using VST devices such as AR glasses.

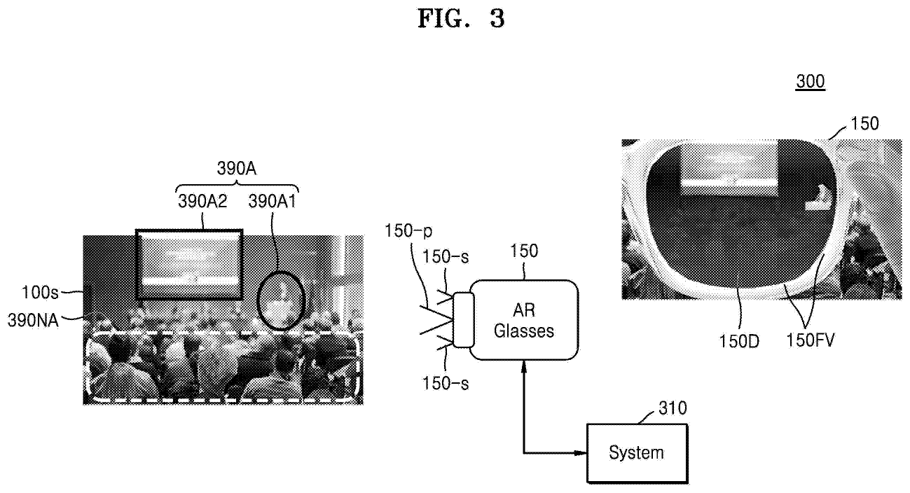

FIG. 3 is a diagram illustrating an example environment 300 comprising a system 310 for enhancing user focus while using a Visual See Through (VST) device (the device 150) during a real-world activity 100S, according to an embodiment of the disclosure. The device 150 may be a Visual See Through (VST) display device such as a Head Mounted Display (HMD) device (e.g., AR glasses), which may be worn on the head of a user or as part of a helmet. The device 150 may be a monocular HMD for one eye or a binocular HMD for both eyes of the user. The real-world activity 100S may be captured via a set of primary one or more cameras 150-P of the device 150 in the form of images or series of images, and the like and rendered on an example display 150D of the example AR glasses 150. The system 310 is communicably coupled with the device 150 for enhancing user focus while engaging in the activity 100S. According to an embodiment of the disclosure, the system 310 resides within the device 150.

According to an embodiment of the disclosure, the device 150 may be a smartphone, a camera, or any other electronic device with capabilities to render Augmented Reality (AR) content having one or more cameras compatible with capturing or recording images, video, etc. of the activity 100S (the real-world scene), without departing from the scope of the disclosure. The device 150 may also include a set of one or more secondary cameras 150-S.

According to an embodiment of the disclosure, the device 150 may include multiple layers, for example, an application layer, a file system layer, etc. The application layer may include a video player application, a gallery application, or a camera application, without departing from the scope of the disclosure. Further, the file system layer may include a file reader, a CoDec, a frame data, and a file writer. The file reader may be configured to read a video recorded by the application layer. The CoDec detects/checks a format of the recorded video (file) and also checks coder-decoder part of the format of the file.

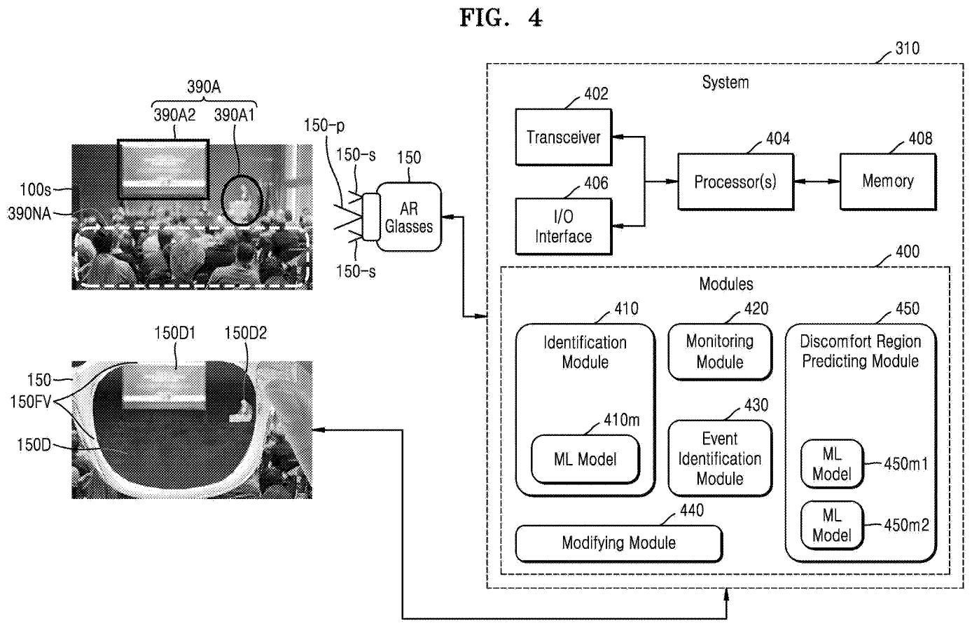

FIG. 4 is a diagram illustrating an example configuration of a system 310 for enhancing the user focus while using the device 150, according to an embodiment of the disclosure. The device 150 may be AR glasses 150. The system 310 includes a plurality of modules 400 including an identification module 410, a monitoring module 420, an event identification module 430, a modifying module 440, and a discomfort region predicting module 450, each of which may include various circuitry and/or executable program instructions. As used herein, the term “circuitry” may include various processing and/or control circuitry configured to operate in accordance with the executable program instructions that may be included in the various modules. The identification module 410 is configured to identify attention regions 390A (such as attention region 390A1, attention region 390A2) and non-attention regions 390NA within a Field-of-View (FOV) 150FV of the AR glasses 150, in connection with a real-world activity 100S associated with the user.

Examples of the real-world activity 100S associated with the user may include driving, viewing XR (Extended Reality) content, working with an electronic device having a content display such as a laptop and the like. As illustrated in the example scenario of FIG. 4, the attention regions 390A1 and 390A2 may pertain to elements of concern directly related to the activity that the user is engaging with in the real-world such as the speaker/presenter (390A1) and the display/presentation (390A2) being made by the speaker during the real-world activity 100S. The non-attention region 390NA pertains to other elements such as the rest of the audience in the real world activity (presentation/meeting) which may not be directly related to the user, or which do not require the user's attention/focus and may act as potential distraction/discomfort.

According to an embodiment of the disclosure, the identification module 410 is configured to receive an input related to the real-world activity 100S from the user of the AR glasses 150. The input may be received from the user of the AR glasses 150 who may be a user and viewer of the AR glasses 150. The input may be received from the user of the AR glasses 150 who may not be a viewer of the AR glasses 150. The identification module 410 is configured to identify the attention regions 390A based on the received input. As an example, the user may provide the input related to the selection of only the presentation display as the region of interest 390A excluding the speaker as well in this scenario.

The system 310 includes a monitoring module 420 configured to monitor real-world events occurring in the identified attention regions 390A and the identified non-attention regions 390NA. According to an embodiment of the disclosure, the monitoring module 420 is configured to continuously monitor a strain in the eyes of the user using one or more capturing devices of the AR glasses 150. According to an embodiment of the disclosure, the one or more capturing devices of the AR glasses 150 may include the secondary cameras 150-S.

The event identification module 430 is configured to identify one or more events causing distraction in the identified attention regions 390A. Examples of the one or more events causing distraction in the identified attention regions 390A may include regions that produce glare from another vehicle while driving (associated activity 100S), regions with advertisement board while driving, regions with high intensity light behind the XR content while viewing XR content, any other light source or keyboard while using the laptop, and the like.

The modifying module 440 is configured to modify display properties of at least a part of an AR display 150D of the AR glasses 150 corresponding to the identified one or more events causing distraction in the identified attention regions 390A. The modifying module 440 may be configured to apply a tint to the identified portions (the display 150D minus portions 150D1, 150D2) of the AR display 150D. The modifying module 440 may be configured to adjust a transparency of the identified portions (the display 150D minus portions 150D1, 150D2) of the AR display 150D. For example, the modifying module 440 may be configured to apply the tint to the non-attention region 390NA only. In another example, the modifying module 440 may be configured to apply the tint to all the regions in the FOV 150FV of the AR glasses 150 except the attention regions 390A1 and 390A2.

According to an embodiment of the disclosure, the system 310 includes a processor (e.g., including processing circuitry) 404, a memory 408, a transceiver 402 and an I/O interface (e.g., including circuitry) 406. According to an embodiment of the disclosure, the system 310 resides within the device 150. The system 310 may be the device 150. The processor 404 may be disposed in communication with a communication network via a network interface. According to an embodiment of the disclosure, the network interface may be the I/O interface 406. The network interface may connect to the communication network to enable the connection of the system 310 with the device 150. The network interface may employ connection protocols including, without limitation, direct connect, Ethernet (e.g., twisted pair 10/100/1000 Base T), transmission control protocol/internet protocol (TCP/IP), token ring, IEEE 702.11a/b/g/n/x, etc. The communication network may include, without limitation, a direct interconnection, local area network (LAN), wide area network (WAN), wireless network (e.g., using Wireless Application Protocol), the Internet, etc. Using the network interface and the communication network, the system 310 may communicate with other devices. The network interface may employ connection protocols including, but not limited to, direct connect, Ethernet (e.g., twisted pair 10/100/1000 Base T), transmission control protocol/internet protocol (TCP/IP), token ring, IEEE 702.11a/b/g/n/x, etc.

According to an embodiment of the disclosure, the memory 408 may be communicatively coupled to the processor 404. The memory 408 may be configured to store data, and instructions executable by the processor 404. The memory 408 may store instructions. According to an embodiment of the disclosure, the memory 408 may be provided within the device 150. According to an embodiment of the disclosure, the memory 408 may be provided within the system 310 being remote from the device 150. According to an embodiment of the disclosure, the memory 408 may communicate with the processor 404 via a bus within the system 310. According to an embodiment of the disclosure, the memory 408 may be located remotely from the processor 404 and may be in communication with the processor 404 via a network. The memory 408 may include, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like.

In an example, the memory 408 may include a cache or random-access memory for the processor 404. In various examples, the memory 408 may be separate from the processor 404, such as a cache memory of a processor, the system memory, or other memory. The memory 408 may be an external storage device or database for storing data. The memory 408 may be operable to store instructions executable by the processor 404. The functions, acts, or tasks illustrated in the figures or described may be performed by the programmed processor 404 for executing the instructions stored in the memory 408. The functions, acts, or tasks are independent of the particular type of instruction set, storage media, processor, or processing strategy and may be performed by software, hardware, integrated circuits, firmware, micro-code, and the like, operating alone or in combination. Likewise, processing strategies may include multiprocessing, multitasking, parallel processing, and the like.

The processor 404 may write data to the memory 408 or read data stored in the memory 408. In particular, the processor 404 may process data according to defined operation rules or an artificial intelligence (AI) model by executing a program or at least one instruction stored in the memory 408. Accordingly, the processor 404 may perform operations described in the following embodiments, and unless otherwise specified, operations described as being performed by the electronic device 150 or by components included in the electronic device 150 may be understood as being performed by the processor 404.

The memory 408 may be a component configured to store various programs or data, and may include a storage medium such as a read-only memory (ROM), random access memory (RAM), hard disk, CD-ROM, DVD, or a combination of such storage media. The memory 408 may not be implemented as a separate component but may be integrated into the processor 404. The memory 408 may include volatile memory, non-volatile memory, or a combination of volatile and non-volatile memory. A program or at least one instruction for performing operations according to the embodiments described below may be stored in the memory 408. The memory 408 may also provide the stored data to the processor 404 in response to a request from the processor 404.

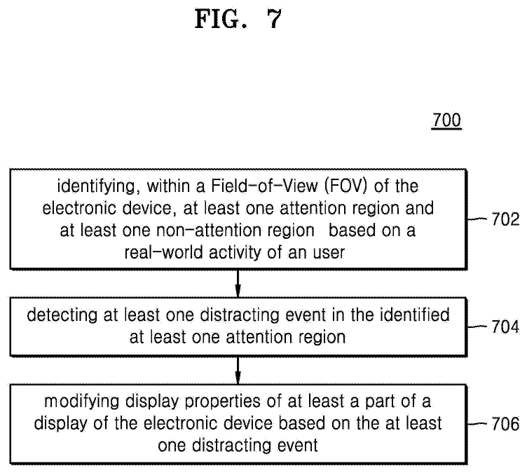

According to an embodiment of the disclosure, the plurality of modules 400 may be included within the memory 408. The plurality of modules 400 may include a set of instructions that may be executed to cause the system 310, for example, the processor 404 of the system 310, to perform any one or more of the methods/processes disclosed herein. The plurality of modules 400 may be configured to perform operations or steps of the disclosure using the data stored in the database. For instance, the plurality of modules 400 may be configured to perform the operations disclosed in FIG. 7.

According to an embodiment of the disclosure, each of the plurality of modules 400 may be a hardware unit which may be outside the memory 408. Further, the memory 408 may include an operating system for performing one or more tasks of the system 310, as performed by a generic operating system. Each of the modules 400 may be in communication with one another and the processor 404. The functionality and working of each of the modules 400 is explained in greater detail with reference to the following Figures.

At least one of the plurality of modules 400 may be implemented through an Artificial Intelligence (AI) or a Machine Learning (ML) model. For example, according to an embodiment of the disclosure, the identification module 410 and the discomfort region predicting module 450 are configured to apply the AI or machine learning models to identify the attention regions 390A (such as attention region 390A1, attention region 390A2) and non-attention regions 390NA. A function associated with the AI models may be performed through a memory 408 (including a non-volatile memory and/or a volatile memory) and a processor 204.

The processor 404 may include one or a plurality of processors. The one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). Thus, the processor 404 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. At least one processor included in the processor 404 may include processing circuitry. The at least one processor included in the processor 404 may execute instructions stored in the memory, individually or collectively. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The one or a plurality of processors control the processing of the input data in accordance with a predefined operating rule, or the AI model stored in the non-volatile memory and the volatile memory. The predefined operating rule or the AI model is provided through training or learning. Being provided through learning may refer, for example, to, by applying a learning technique to a plurality of learning data, a predefined operating rule or AI model of a desired characteristic being made. The learning may be performed in a device itself in which AI according to an embodiment is performed, and/or may be implemented through a separate server/system.

The AI model may include a plurality of neural network layers. Each layer has a plurality of weight values and performs a layer operation through calculation of a previous layer and an operation of a plurality of weights. Examples of neural networks include, but are not limited to, a Convolutional Neural Network (CNN), a Deep Neural Network (DNN), a Recurrent Neural Network (RNN), a Restricted Boltzmann Machine (RBM), a Deep Belief Network (DBN), a Bidirectional Recurrent Deep Neural Network (BRDNN), a Generative Adversarial Networks (GAN), deep Q-networks, or the like.

The learning technique may refer to a method for training a predetermined target device (for example, a robot) using a plurality of learning data to cause, allow, or control the target device to make a determination or prediction. Examples of learning techniques include, but are not limited to, supervised learning, unsupervised learning, semi-supervised learning, or reinforcement learning. According to an embodiment of the disclosure, the ML models 410m, 450m1, and 450m2 may be pretrained.

The AI model may be obtained by training. Being “obtained by training” may refer, for example, to a predefined operation rule or AI model configured to perform a desired feature (or purpose) is obtained by training a basic artificial intelligence model with multiple pieces of training data by a training technique. The artificial intelligence model may include a plurality of neural network layers. Each of the plurality of neural network layers includes a plurality of weight values and performs neural network computation by computation between a result of computation by a previous layer and the plurality of weight values.

Reasoning prediction may refer, for example, to a technique of logical reasoning and predicting by determining information and includes, e.g., knowledge-based reasoning, optimization prediction, preference-based planning, or recommendation.

The memory 408 may include an operating system for performing one or more tasks of the system 310, as performed by a generic operating system. Each of the modules 400 may be in communication with one another and the processor 404. The working and functioning of the plurality of modules 400 of the system 310 have been described in detail with reference to the following Figures. According to an embodiment of the disclosure, the system 310 may be located within the receiver device.

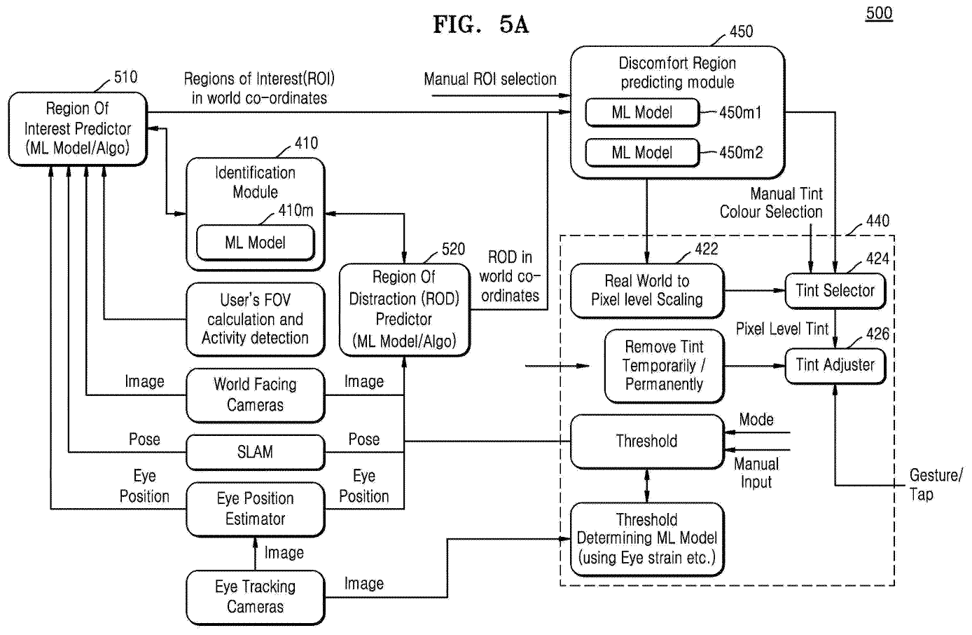

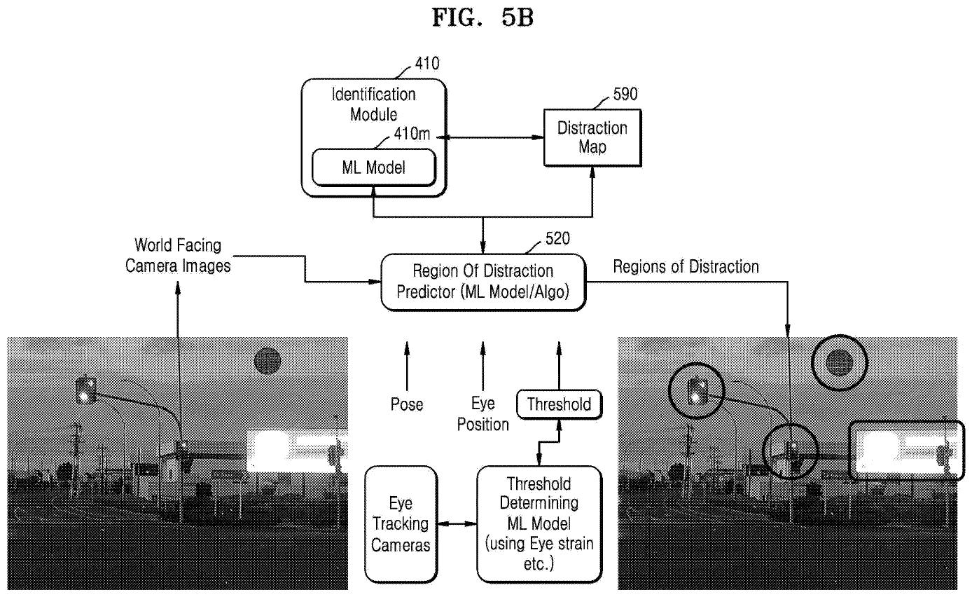

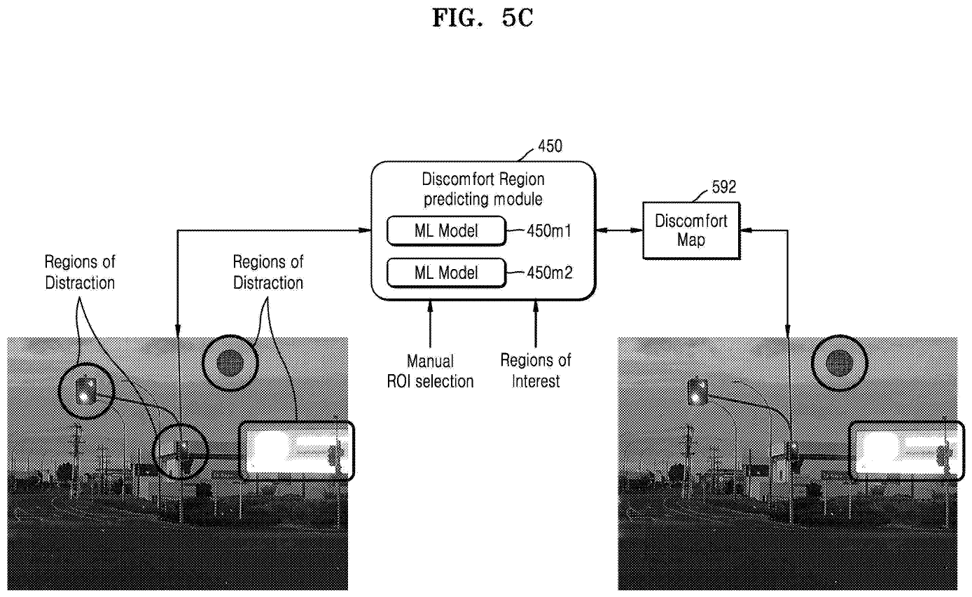

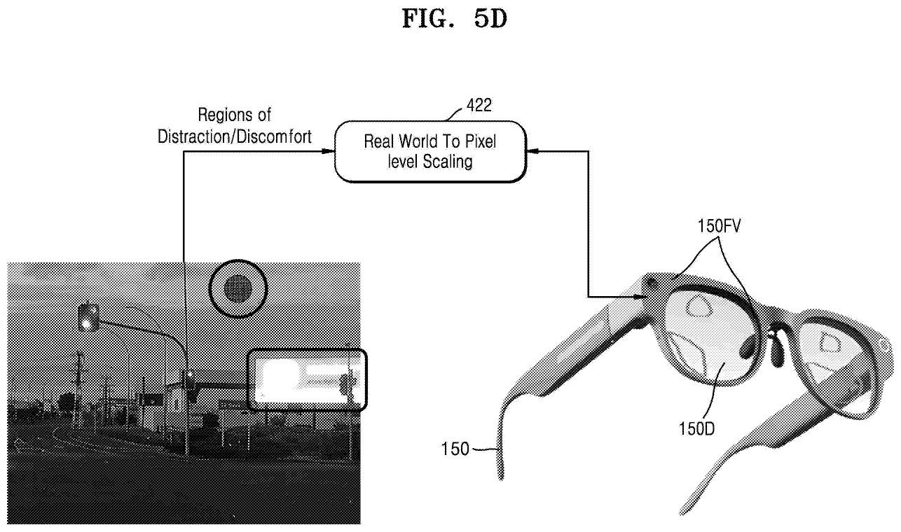

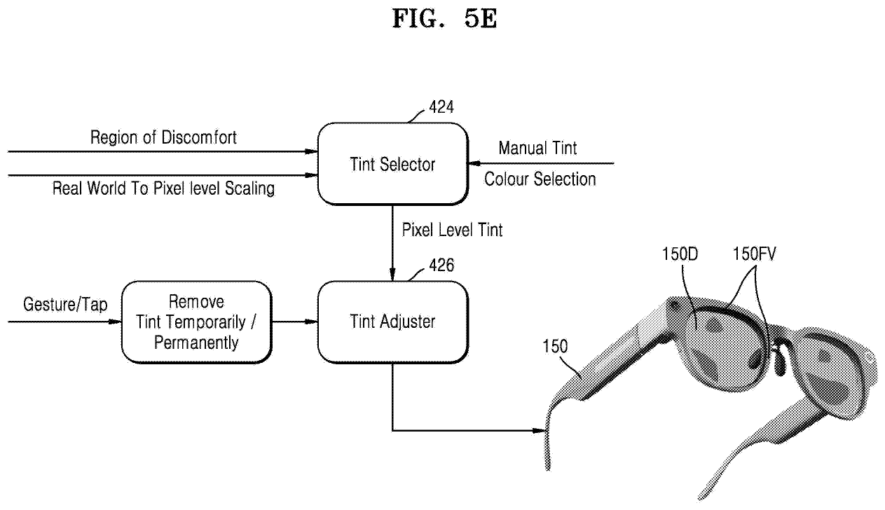

FIG. 5A is a diagram illustrating example process flow 500 of the system 310 for enhancing the user focus while using the AR glasses 150, according to an embodiment of the disclosure. The identification module 410 may include a region of interest predictor module (e.g., including various circuitry and/or executable program instructions) 510 including ML models. The region of interest predictor module 510 may be configured to identify the attention regions 390A within the Field-of-View (FOV) 150FV. The attention regions 390A pertain to the real-world activity such as attending a conference, wherein the presentation being displayed and the speaker involved in the real-world activity may be the activities of interest for the user of the AR glasses. The attention regions 390A include the attention regions 390A and the non-attention regions 390NA connected to the real-world activity 100S associated with the user. For example, the identified attention regions 390A includes the attention region 390A1 (the speaker) and the attention region 390A2 (the presentation being displayed).

FIG. 5B is a diagram illustrating example working of the identification module 410, according to an embodiment of the disclosure. According to an embodiment of the disclosure, the identification module 410 may include a region of distraction predictor module (e.g., including various circuitry and/or executable program instructions) 520 configured to generate a distraction map 590 based on a head-position tracking of the user and inputs from one or more capturing devices such as, for example, the set of secondary cameras 150-S of the AR glasses 150. According to an embodiment of the disclosure, the AR glasses 150 may be equipped with cameras, eye-tracking sensors, and environment sensors such as ambient light sensors, Inertial Measurement Units (IMUs), and the like, for continuously monitoring the head-position tracking of the user such as the user's gaze to detect the user's focus regions in the FOV. As an example, the region of distraction predictor module 520 may take inputs from world-facing cameras, SLAM, and head position tracking to analyze the environment.

The region of distraction predictor module 520 may generate a distraction map 590 using Machine Learning Models such as the ML model 410m of the identification module 410. The distraction map 590 includes locations of the attention regions 390A and the non-attention regions 390NA in the FOV 150FV. The region of distraction predictor module 520 may detect bright lights, fast-moving objects, and visual clutter using predefined thresholds or the ML models trained on distraction patterns. The system 310 may be configured to prioritize distractions based on a location, size of the distraction, and motion relative to the user's focus. The region of distraction predictor module 520 outputs the distraction map 590, marking areas that could interfere with attention or cause visual overload.

FIG. 5C is a diagram illustrating example working of a discomfort region predicting module 450 of the system 310 for enhancing the user focus while using the AR glasses 150, according to an embodiment of the disclosure. According to an embodiment of the disclosure, the system 310 includes the discomfort region predicting module (e.g., including various circuitry and/or executable program instructions) 450. The discomfort region predicting module 450 is configured to predict at least one region of discomfort impacting the real-world activity 100S. The discomfort region predicting module 450 is configured to detect a type of distraction and a region of distraction associated with the identified one or more events causing the distraction in the identified attention regions 390A. The discomfort region predicting module 450 is configured to predict the at least one region of discomfort by correlating the identified attention regions 390A, and the detected type of distraction and the detected region of distraction.

According to an embodiment of the disclosure, the discomfort region predicting module 450 may be configured to receive inputs associated with regions of interest selection related to the real-world activity 100S from the user of the AR glasses 150. The input may be received from the user of the AR glasses 150 who may not be a viewer. The discomfort region predicting module 450 may be configured to identify the at least one region of discomfort impacting the real-world activity based on the received input.

According to an embodiment of the disclosure, the discomfort region predicting module 450 is configured to track a head-position of the user during the occurrence of the event. Further, the discomfort region predicting module 450 is configured to receive inputs from one or more capturing devices of the AR glasses. Furthermore, the discomfort region predicting module 450 is configured to generate a discomfort map 592, using Machine Learning Models such as an ML model 450m1 of the discomfort region predicting module 450. The discomfort map 592 is generated based on the tracking of the head-position and the received inputs from the one or more capturing devices. The discomfort map 592 may include markings for the location of the at least one region of discomfort.

According to an embodiment of the disclosure, the discomfort region predicting module 450 is configured to compare luminance levels of the identified attention regions 390A with a predetermined threshold luminance value. Further, the discomfort region predicting module 450 is configured to identify one or more portions of the identified attention regions 390A as the at least one region of discomfort based on the comparison when a luminance level of a portion of the identified attention regions 390A is more than the predetermined threshold luminance value.

According to an embodiment of the disclosure, the discomfort region predicting module 450 is configured to set the predetermined threshold luminance value at an initial predetermined luminance value. Further, the discomfort region predicting module 450 is configured to adjust, dynamically using an ML model 450m2 of the discomfort region predicting module 450, a value for the predetermined threshold luminance value based on continuous monitoring of a strain in the eyes of the user using the one or more capturing devices of the AR glasses 150.

In an example scenario, the system 310 may be configured to continuously monitor the user's eye behavior including rapid movements or signs of discomfort (e.g., squinting or focusing on a bright area). If a bright light or distraction is partially occluded but still causing discomfort, the system 310 may be configured to dynamically increase the predetermined threshold luminance value (the discomfort detection threshold). Consequently, a further darkening or occluding of the identified region in the FOV 150FV is achieved ensuring enhancement of user focus. This adaptive feedback mechanism based on the user's eye monitoring ensures that the AR glasses 150 respond, intelligently, to user behavior for maximum comfort and focus.

FIGS. 5D and 5E are diagrams illustrating example working of the modifying module 440, according to an embodiment of the disclosure. According to an embodiment of the disclosure, the modifying module 440 may be configured to identify portions of the AR display 150D corresponding to the at least one predicted region of discomfort by mapping coordinates of the real-world to the AR display 150D using a real-world-to-pixel-level scaling module 422 based on eye-position tracking of the user. The modifying module 440 is configured to apply a tint to the identified portions of the AR display 150D.

According to an embodiment of the disclosure, the modifying module 440 may include the real-world-to-pixel-level scaling module 422 configured for identifying the distraction regions from the world coordinate system and mapping the distraction regions to the display 150D of the AR glasses 150. Using eye position tracking, the real-world-to-pixel-level scaling module 422 may calculate how these distractions will project onto the user's FOV 150FV. Further, the real-world-to-pixel-level scaling module 422 may be configured for adjusting for perspective, distortion, and display resolution to ensure accurate alignment. The real-world-to-pixel-level scaling module 422 outputs pixel-level coordinates, allowing precise modification of distractions on the AR display 150D.

According to an embodiment of the disclosure, the modifying module 440 is configured to receive an input from the user related to a tint color, select a tint color for applying the tint based on the received input; and apply the tint to the identified portions of the AR display 150D corresponding to the selected tint color.

In various example scenarios, for example, for regions that produce glare from another vehicle while driving, the system 310 is configured to add tint to the regions that produce the glare. Similarly, for regions with advertisement board while driving, the system 310 is configured to identify regions with advertisement boards and add tint to the regions while simultaneously not obscuring the traffic signals or road signals. For regions with high intensity light behind the XR content while viewing XR content, any other light source or keyboard while using the laptop, the system 310 is configured to add tint to the identified regions.

According to an embodiment of the disclosure, the modifying module 440 is configured to allow the user to manually configure or fine-tune preferences (e.g., preferred tint levels or color adjustments) through a connected app or voice commands for specific scenarios. For example, the user may be driving on a sunny day. The system 310 may detect the excessive glare from the sun and darken the top portion of the glasses to reduce discomfort. Simultaneously, the system 310 is configured to highlight key areas such as road signs or GPS directions by adjusting the tint to make the key areas more prominent. In various example scenarios, when a distracting billboard enters the field of view 150FV, the system 310 is configured to dim the specific region of the AR glasses 150 helping the user to stay focused on the road.

According to an embodiment of the disclosure, the modifying module 440 may be configured to adjust a transparency of the identified portions of the AR display.

According to an embodiment of the disclosure, the system 310 may include a tint selector module 424 configured to receive inputs from the discomfort region predicting module 450 and the real-world-to-pixel-level scaling module 422, each of which may include various circuitry and/or executable program instructions, to determine where tinting is needed. Based on the inputs, an appropriate tint intensity and color for each pixel is calculated and sent to a tint adjuster module 426 of the system 310. The tint adjuster module 426 uses the processed pixel values from the tint selector module 424 and dynamically applies the tint to the display 150D. The pixel transparency and color are modified to reduce distractions from the non-attention regions 390NA while maintaining the visibility of important regions (the attention regions 390A).

The system 310 is configured to remove the tint based on a gesture-based control over the applied tint. For example, the user may perform a specific gesture or tap for indicating that the tint applied be removed either temporarily (for a quick glance) or permanently (until manually reapplied). This ensures flexibility in adjusting visibility based on changing needs.

As an example, a special film embedded in the AR glasses 150 may change an opacity and color of the AR glasses 150 dynamically across an entire lens or at specific regions of the lens (display 150D) of the AR glasses 150. The lens of the AR glasses may be the same as or similar to the display 150D. The special film may include advanced materials that respond to electrical signals to modulate tint and color instantly, such as electrochromic, liquid crystal-based technology, and the like.

In an example scenario, the system 310 may selectively darken or lighten regions in the user's field of view 150FV to reduce glare or block out distractions. Colors may also be adjusted (e.g., enhancing contrast by tinting in blue or red) to highlight important objects or text. The system 310 may continuously monitor changes in the user's environment and adapts in real time. For instance, if the lighting changes, such as when entering a tunnel, the tint adjusts instantly to improve visibility for the user.

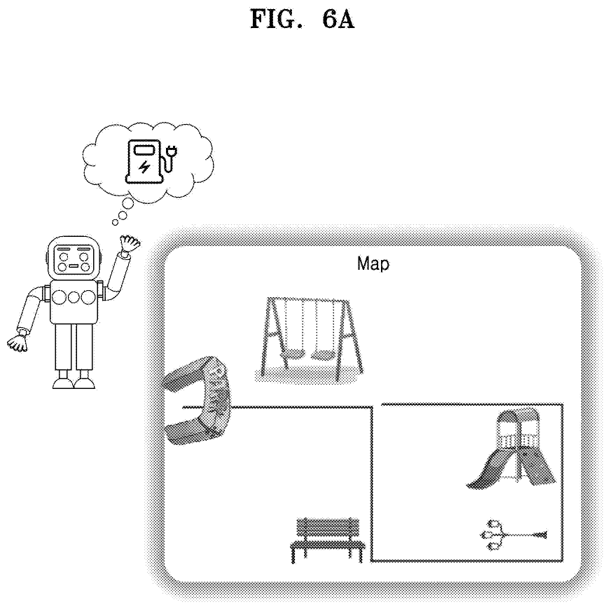

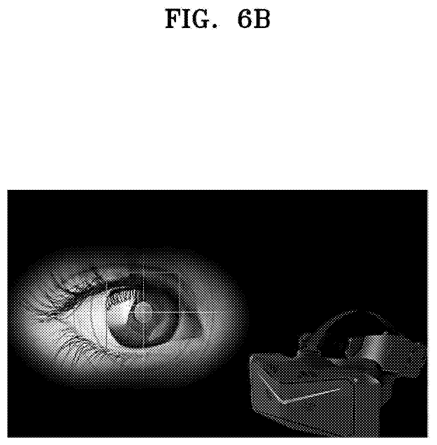

FIGS. 6A and 6B are diagrams illustrating examples of the one or more capturing devices of the AR glasses 150, according to an embodiment of the disclosure.

FIG. 6A illustrates SLAM (Simultaneous Localization and Mapping), a computational technique used in robotics to construct maps of unknown environments while simultaneously tracking a position of the robot position within those environments. With reference to the example scenario shown in FIG. 6A, a mobile robot may want to find a charging station. It first sees a park gate and adds it to its map. Then it moves forward and finds a swing to its left. It adds it to its map, takes a right and moves forward to find a park bench to its right. It then adds it to its map, takes a left and moves forward to find a lamp to its left. It adds it to its map, takes a left and moves forward to find a slide to its left. It adds it to its map, takes a left and moves forward to find the same swing to its right.

Since the robot has created the map and localized in it, now it knows that it has to take a right, since it has explored the other areas. If SLAM is not performed, the robot might move randomly and may not be able to search the complete area, which is inefficient.

FIG. 6B illustrates an example eye-tracking camera of the AR glasses 150. The eye-tracking cameras may use Infra-Red (IR) light and sensors to monitor eye movements of the user. The IR light may illuminate the eyes, and the eye-tracking cameras may capture reflections from the cornea and pupils of the user of the AR glasses 150. In an example scenario, for blink detection, the changes in the eye's appearance may be tracked. When the eyelids close, the reflection pattern changes, signalling a blink.

At least one of the monitoring module 420, the ML models such as the ML models 410m, 450m1, and 450m2 may analyze sensor data in real time to determine a current activity/task associated with the user. For example, if the user is driving, the system 310 is configured to identify potential distractions like bright billboards or reflective surfaces and adjusts accordingly.

FIG. 7 is a flowchart illustrating an example method 700 for enhancing user focus while using the device 150, according to an embodiment of the disclosure.

Referring to FIGS. 3-6 together, the method 700 may be performed by the device 150 such as a camera device having the pass-through mode, e.g., a camcorder, a mobile device, a tab with similar capabilities, and the like, based on instructions retrieved from non-transitory computer-readable media. The device 150 may be a Visual See Through (VST) display device such as a Head Mounted Display (HMD) device (e.g., AR glasses), which may be worn on the head of a user or as part of a helmet. The device 150 may be a monocular HMD for one eye or a binocular HMD for both eyes of the user. The real-world activity 100S may be captured via a set of primary one or more cameras 150-P of the device 150 in the form of images or series of images, and the like and rendered on an example display 150D of the example AR glasses 150.

A computer-readable media may include machine-executable or computer-executable instructions to perform all or portions of the method 700. The computer-readable media may be, for example, digital memories, magnetic storage media, such as magnetic disks and magnetic tapes, hard drives, or optically readable data storage media.

The method 700 includes a series of operations shown at 702 through 706 of FIG. 7. The method 700 may be performed by the system 310 in conjunction with one or more modules 400, the details of which are explained in conjunction with FIGS. 3-6, above and the same or overlapping descriptions may not be repeated here for the sake of brevity.

At operation 702, the method 700 may include identifying at least one attention region 390A (such as attention region 390A1, attention region 390A2) and at least one non-attention region 390NA within a Field-of-View (FOV) 150FV of the electronic device 150, based on a real-world activity 100S of an user. Examples of the real-world activity 100S associated with the user may include driving, viewing XR content, working with an electronic device having content display such as a laptop and the like.

According to an embodiment of the disclosure, the method 700 may include generating a distraction map 590 based on a head-position tracking of the user and a first input from a capturing device such as, for example, the set of secondary cameras 150-S of the electronic device 150. According to an embodiment of the disclosure, the electronic device 150 may be equipped with cameras, eye-tracking sensors, and environment sensors such as ambient light sensors, IMUs, and the like, for continuously monitoring the head-position tracking of the user such as the user's gaze to detect the user's focus regions in the FOV. The distraction map 590 may include location of the at least one attention region 390A and the at least one non-attention regions 390NA in the FOV 150FV.

According to an embodiment of the disclosure, the method 700 may include receiving a second input related to the real-world activity 100S and identifying the at least one attention region 390A based on the received second input.

According to an embodiment of the disclosure, the method 700 may include monitoring real-world events occurring in the identified at least one attention region 390A and the identified at least one non-attention region 390NA. According to an embodiment of the disclosure, the method 700 may include monitoring a strain in eyes of the user using the capturing device.

At operation 704, the method 700 may include detecting at least one distracting event in the identified at least one attention region 390A. Examples of the at least one distracting event in the identified at least one attention region 390A may include regions that produce glare from another vehicle while driving, regions with advertisement board while driving, regions with high intensity light behind the XR content while viewing XR content, any other light source or keyboard while using the laptop.

According to an embodiment of the disclosure, the method 700 may include predicting at least one region of discomfort impacting the real-world activity 100S. The method 700 may include detecting a type of distraction and a region of distraction associated with the at least one distracting event. The method 700 may include predicting the at least one region of discomfort impacting the real-world activity, based on at least one of the identified at least one attention region 390A, the detected type of distraction, and the detected region of distraction.

According to an embodiment of the disclosure, the method 700 may include tracking a head-position of the user. Further, the method 700 may include receiving the first input from the capturing device. The method 700 may include generating a discomfort map 592, using Machine Learning Models such as an ML model 450m1 of the discomfort region predicting module 450. The discomfort map 592 may be generated based on the tracking of the head-position and the received first input from the capturing devices. The discomfort map 592 may include marking for location of the at least one region of discomfort.

According to an embodiment of the disclosure, the method 700 may include comparing luminance levels of the identified at least one attention region 390A with a threshold luminance value. The threshold luminance value may be a predetermined or specified threshold luminance value. The method 700 may include identifying one or more portions of the identified at least one attention region 390A as the at least one region of discomfort, based on the comparison.

According to an embodiment of the disclosure, the method 700 may include setting the threshold luminance value at an initial luminance value. The method 700 may include adjusting, dynamically using an ML model 450m2, the threshold luminance value based on monitoring of a strain in eyes of the user using the capturing device.

At operation 706, the method 700 may include modifying display properties of at least a part of a display 150D of the electronic device 150 based on the at least one distracting event.

According to an embodiment of the disclosure, the method 700 may include applying a tint to the identified one or more portions of the display 150D. According to an embodiment of the disclosure, the method 700 may include adjusting a transparency of the identified one or more portions of the AR display 150D.

According to an embodiment of the disclosure, the method 700 may include identifying one or more portions of the display 150D corresponding to the at least one predicted region of discomfort by mapping coordinates of the real-world to the display 150D using a real-world-to-pixel-level scaling based on eye-position tracking of the user. Subsequently, the method 700 may include applying a tint to the identified one or more portions of the display 150D.

According to an embodiment of the disclosure, the method 700 may include receiving a third input related to a tint color, selecting the tint color for applying the tint based on the received third input; and applying the tint to the identified one or more portions of the display 150D based on the selected tint color.

The system and method of the disclosure dynamically adjust the tint of AR glasses based on the user's focus and activity. By identifying regions of interest and distractions, the system and method of the disclosure create a more personalized and efficient augmented reality experience by enhancing user focus and reducing cognitive load, making AR applications more effective and user-friendly.

The system and method of the disclosure achieves dynamic glare reduction, selective occlusion, and personalized tinting, and may be adapted to other applications such as automotive, defence, and industrial applications. The AR glasses 150 may use a transparent OLED screens along with display lenses. These screens can control how much light passes through, making some areas darker while keeping others clear. Tiny LEDs may be used in the inside of the OLEDs selectively adjust brightness or darkness in specific areas, helping the user focus on important information. The disclosure, due to continuous monitoring, achieves continuous adjustment of the transparency and tint in real time, providing a seamless and comfortable AR experience even as the user moves or shifts focus.

The method and system of the disclosure provide regional lux value based adaptive tint for better visibility while driving. Further, the disclosure contemplates adaptive tint with different matching colours as per latest fashion trends and regional lux value as per AR content location (e.g., switching from low lux to high lux environment). The method and system may also provide for blocking out sensitive content/areas from a user's view.

According to an embodiment of the disclosure, a method for enhancing user focus while using Augmented-Reality (AR) glasses may be provided. The method may include identifying, within a Field-of-View (FOV) of the AR glasses, attention regions and non-attention regions in connection with a real-world activity associated with the user. The method may include monitoring real-world events occurring in the identified attention regions and the identified non-attention regions. The method may include identifying one or more events causing distraction in the identified attention regions. The method may include modifying display properties of at least a part of an AR display of the AR glasses corresponding to the identified one or more events causing distraction in the identified attention regions.

According to an embodiment of the disclosure, the identifying the at least one attention region and the at least one non-attention region may comprise generating a distraction map based on a head-position tracking of the user and a first input from a capturing device of the electronic device. The distraction map may include location of the at least one attention region and the at least one non-attention region in the FOV.

According to an embodiment of the disclosure, the identifying the attention regions and the non-attention regions may comprise generating a distraction map, using Machine Learning Models, based on a head-position tracking of the user and inputs from one or more capturing devices of the AR glasses (150). The distraction map may include locations of the attention regions (390A) and the non-attention regions (390NA) in the FOV.

According to an embodiment of the disclosure, the identifying the at least one attention region and the at least one non-attention region may comprise receiving a second input related to the real-world activity of the user. The identifying the at least one attention region and the at least one non-attention region may comprise identifying the at least one attention region based on the received second input.

According to an embodiment of the disclosure, the identifying the attention regions and the non-attention regions may comprise receiving, from the user of the AR glasses, an input related to the real-world activity associated with the user. The identifying the attention regions and the non-attention regions may comprise identifying the attention regions based on the received input.

According to an embodiment of the disclosure, the method may include detecting a type of distraction and a region of distraction associated with the at least one distracting event. The method may include predicting at least one region of discomfort impacting the real-world activity, based on at least one of the identified at least one attention region, the detected type of distraction, and the detected region of distraction.

According to an embodiment of the disclosure, the method may include predicting at least one region of discomfort impacting the real-world activity by: detecting a type of distraction and a region of distraction associated with the identified one or more events causing the distraction in the identified attention regions, and predicting the at least one region of discomfort by correlating: the identified attention regions, and the detected type of distraction and the detected region of distraction.

According to an embodiment of the disclosure, the predicting the at least one region of discomfort impacting the real-world activity may comprise tracking a head-position of the user. The predicting the at least one region of discomfort impacting the real-world activity may comprise receiving the first input from the capturing device. The predicting the at least one region of discomfort impacting the real-world activity may comprise generating a discomfort map based on the tracking of the head-position and the received first input from the capturing device. The distraction map may include marking for location of the at least one region of discomfort.

According to an embodiment of the disclosure, the predicting the at least one region of discomfort impacting the real-world activity associated with the user may comprise tracking a head-position of the user during the occurrence of the event. The predicting the at least one region of discomfort impacting the real-world activity associated with the user may comprise receiving inputs from one or more capturing devices of the AR glasses. The predicting the at least one region of discomfort impacting the real-world activity associated with the user may comprise generating a discomfort map, using Machine Learning Models, based on the tracking of the head-position and the received inputs from the one or more capturing devices. The distraction map may include markings for the location of the at least one region of discomfort.

According to an embodiment of the disclosure, the predicting the at least one region of discomfort impacting the real-world activity may comprise comparing luminance level of the identified at least one attention region with a threshold luminance value. The predicting the at least one region of discomfort impacting the real-world activity may comprise based on the comparison, identifying one or more portions of the identified at least one attention region as the at least one region of discomfort.

According to an embodiment of the disclosure, the predicting the at least one region of discomfort impacting the real-world activity may comprise comparing luminance levels of the identified attention regions with a predetermined threshold luminance value. The predicting the at least one region of discomfort impacting the real-world activity may comprise identifying one or more portions of the identified attention regions as the at least one region of discomfort based on the comparison when a luminance level of a portion of the identified attention regions is more than the predetermined threshold luminance value.

According to an embodiment of the disclosure, the predicting the at least one region of discomfort impacting the real-world activity may comprise setting the threshold luminance value at an initial luminance value. The predicting the at least one region of discomfort impacting the real-world activity may comprise adjusting the threshold luminance value based on monitoring of a strain in eyes of the user using the capturing device.

According to an embodiment of the disclosure, the predicting the at least one region of discomfort impacting the real-world activity may comprise setting the predetermined threshold luminance value at an initial predetermined luminance value. The predicting the at least one region of discomfort impacting the real-world activity may comprise adjusting, dynamically using ML models, the value of the predetermined threshold luminance value based on continuous monitoring of a strain in the eyes of the user using one or more capturing devices of the AR glasses.

According to an embodiment of the disclosure, the modifying the display properties of the at least part of the display may comprise identifying one or more portions of the display corresponding to the at least one predicted region of discomfort by mapping coordinates of the real-world to the display using real-world-to-pixel-level scaling based on eye-position tracking of the user. The modifying the display properties of the at least part of the display may comprise receiving a second input related to a tint color. The modifying the display properties of the at least part of the display may comprise selecting the tint color for applying the tint based on the received second input. The modifying the display properties of the at least part of the display may comprise applying a tint to the identified one or more portions of the display based on the selected tint color. The modifying the display properties of the at least part of the display may comprise adjusting a transparency of the identified one or more portions of the display.

According to an embodiment of the disclosure, the modifying the display properties of the at least part of the AR display may comprise identifying portions of the AR display corresponding to the at least one predicted region of discomfort by mapping coordinates of the real-world to the AR display using real-world-to-pixel scaling based on eye-position tracking of the user. The modifying the display properties of the at least part of the AR display may comprise applying a tint to the identified portions of the AR display.

According to an embodiment of the disclosure, the modifying the display properties of the at least part of the AR display may comprise receiving an input from the user related to a tint color. The modifying the display properties of the at least part of the AR display may comprise selecting a tint color for applying the tint based on the received input. The modifying the display properties of the at least part of the AR display may comprise applying the tint to the identified portions of the AR display corresponding to the selected tint color.

According to an embodiment of the disclosure, the modifying the display properties of the at least part of the AR display may comprise adjusting a transparency of the identified portions of the AR display.

According to an embodiment of the disclosure, a system for enhancing user focus while using Augmented-Reality (AR) glasses may be provided. The system may comprise an identification module configured to identify, within a Field-of-View (FOV) of the AR glasses, attention regions and non-attention regions in connection with a real-world activity associated with the user. The system may comprise a monitoring module configured to monitor real-world events occurring in the identified attention regions and the identified non-attention regions. The system may comprise an event identification module configured to identify one or more events causing distraction in the identified attention regions. The system may comprise a modifying module configured to modify display properties of at least a part of an AR display of the AR glasses corresponding to the identified one or more events causing distraction in the identified attention regions.

According to an embodiment of the disclosure, the at least one processor individually or collectively executes the instructions to cause the electronic device to generate a distraction map based on a head-position tracking of the user and a first input from a capturing device of the electronic device. The distraction map may include location of the at least one attention region and the at least one non-attention region in the FOV.

According to an embodiment of the disclosure, the identification module is configured to generate a distraction map, using Machine Learning Models, based on a head-position tracking of the user and inputs from one or more capturing devices of the AR glasses, the distraction map including locations of the attention regions and the non-attention regions in the FOV.

According to an embodiment of the disclosure, the at least one processor individually or collectively executes the instructions to cause the electronic device to receive a second input related to the real-world activity of the user. The at least one processor individually or collectively executes the instructions to cause the electronic device to identify the at least one attention region based on the received second input.

According to an embodiment of the disclosure, the identification module (410) is configured to receive, from the user of the AR glasses, an input related to the real-world activity associated with the user. The identification module (410) is configured to identify the attention regions based on the received input.

According to an embodiment of the disclosure, the at least one processor individually or collectively executes the instructions to further cause the electronic device to detect a type of distraction and a region of distraction associated with the at least one distracting event. The at least one processor individually or collectively executes the instructions to further cause the electronic device to predict at least one region of discomfort impacting the real-world activity, based on at least one of the identified at least one attention region, the detected type of distraction, and the detected region of distraction.

According to an embodiment of the disclosure, the system may comprise a discomfort region predicting module configured to predict at least one region of discomfort impacting the real-world activity by detecting a type of distraction and a region of distraction associated with the identified one or more events causing the distraction in the identified attention regions, and predicting the at least one region of discomfort by correlating the identified attention regions, and the detected type of distraction and the detected region of distraction.

According to an embodiment of the disclosure, the at least one processor individually or collectively executes the instructions to cause the electronic device to track a head-position of the user. The at least one processor individually or collectively executes the instructions to cause the electronic device to receive the first input from the capturing device. The at least one processor individually or collectively executes the instructions to cause the electronic device to generate a discomfort map based on the tracking of the head-position and the received first input from the capturing device. The distraction map includes marking for location of the at least one region of discomfort.

According to an embodiment of the disclosure, the discomfort region predicting module is configured to track a head-position of the user during the occurrence of the event. The discomfort region predicting module is configured to receive inputs from one or more capturing devices of the AR glasses. The discomfort region predicting module is configured to generate a discomfort map, using Machine Learning Models, based on the tracking of the head-position and the received inputs from the one or more capturing devices. The distraction map may include markings for the location of the at least one region of discomfort.

According to an embodiment of the disclosure, the at least one processor individually or collectively executes the instructions to cause the electronic device to compare luminance level of the identified at least one attention region with a threshold luminance value. The at least one processor individually or collectively executes the instructions to cause the electronic device to based on the comparison, identify one or more portions of the identified at least one attention region as the at least one region of discomfort.

According to an embodiment of the disclosure, the discomfort region predicting module is configured to compare luminance levels of the identified attention regions with a predetermined threshold luminance value. The discomfort region predicting module is configured to identify one or more portions of the identified attention regions as the at least one region of discomfort based on the comparison when a luminance level of a portion of the identified attention regions is more than the predetermined threshold luminance value.

According to an embodiment of the disclosure, the at least one processor individually or collectively executes the instructions to cause the electronic device to set the threshold luminance value at an initial luminance value. The at least one processor individually or collectively executes the instructions to cause the electronic device to adjust the threshold luminance value based on monitoring of a strain in eyes of the user using the capturing device.

According to an embodiment of the disclosure, the discomfort region predicting module is configured to set the predetermined threshold luminance value at an initial predetermined luminance value. The discomfort region predicting module is configured to adjust, dynamically using ML models, the value of the predetermined threshold luminance value based on continuous monitoring of a strain in the eyes of the user using one or more capturing devices of the AR glasses.

According to an embodiment of the disclosure, the at least one processor individually or collectively executes the instructions to cause the electronic device to identify one or more portions of the display corresponding to the at least one predicted region of discomfort by mapping coordinates of the real-world to the display using real-world-to-pixel-level scaling based on eye-position tracking of the user. The at least one processor individually or collectively executes the instructions to cause the electronic device to receive a second input related to a tint color. The at least one processor individually or collectively executes the instructions to cause the electronic device to select the tint color for applying the tint based on the received second input. The at least one processor individually or collectively executes the instructions to cause the electronic device to apply a tint to the identified one or more portions of the display based on the selected tint color. The at least one processor individually or collectively executes the instructions to cause the electronic device to adjust a transparency of the identified one or more portions of the display.

According to an embodiment of the disclosure, the modifying module is configured to identify portions of the AR display corresponding to the at least one predicted region of discomfort by mapping coordinates of the real-world to the AR display using real-world-to-pixel scaling based on eye-position tracking of the user. The modifying module is configured to apply a tint to the identified portions of the AR display.

According to an embodiment of the disclosure, the modifying module is configured to receive an input from the user related to a tint color. The modifying module is configured to select a tint color for applying the tint based on the received input. The modifying module is configured to apply the tint to the identified portions of the AR display corresponding to the selected tint color.

According to an embodiment of the disclosure, the modifying module is configured to adjust a transparency of the identified portions of the AR display.

While specific language has been used to describe the disclosure, any limitations arising on account of the same are not intended. As will be apparent to one skilled in the art, various working modifications may be made to the method in order to implement the concept as taught herein.

The drawings and the foregoing description give examples of various embodiments. Those skilled in the art will appreciate that one or more of the described elements may well be combined into a single functional element. Certain elements may be split into multiple functional elements. Elements from an embodiment may be added to an embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the disclosure or not, such as differences in structure, dimension, and use of material, are possible. The scope of various embodiments is at least as broad as given by the following claims.

Benefits, other advantages, and solutions to problems have been described above with regard to example embodiments. However, the benefits, advantages, solutions to problems, and any component(s) that may cause any benefit, advantage, or solution to occur or become more pronounced are not to be construed as a critical, required, or essential feature or component of any or all the claims.

What is claimed is:

1. A method performed by an electronic device, the method comprising:
identifying, within a Field-of-View (FOV) of the electronic device, at least one attention region and at least one non-attention region based on a real-world activity of an user;
detecting at least one distracting event in the identified at least one attention region; and
modifying display properties of at least a part of a display of the electronic device based on the at least one distracting event.

2. The method of claim 1, wherein identifying the at least one attention region and the at least one non-attention region comprises:
generating a distraction map based on a head-position tracking of the user and a first input from a capturing device of the electronic device,
wherein the distraction map includes location of the at least one attention region and the at least one non-attention region in the FOV.

3. The method of claim 1, wherein identifying the at least one attention region and the at least one non-attention region comprises:
receiving a second input related to the real-world activity of the user; and
identifying the at least one attention region based on the received second input.

4. The method of claim 1, further comprising:
detecting a type of distraction and a region of distraction associated with the at least one distracting event; and
predicting at least one region of discomfort impacting the real-world activity, based on at least one of the identified at least one attention region, the detected type of distraction, and the detected region of distraction.

5. The method of claim 4, wherein predicting the at least one region of discomfort impacting the real-world activity comprises:
tracking a head-position of the user;
receiving the first input from the capturing device; and
generating a discomfort map based on the tracking of the head-position and the received first input from the capturing device,
wherein the distraction map includes marking for location of the at least one region of discomfort.

6. The method of claim 4, wherein predicting the at least one region of discomfort impacting the real-world activity comprises:
comparing luminance level of the identified at least one attention region with a threshold luminance value; and
based on the comparison, identifying one or more portions of the identified at least one attention region as the at least one region of discomfort.

7. The method of claim 6, wherein predicting the at least one region of discomfort impacting the real-world activity comprises:
setting the threshold luminance value at an initial luminance value; and
adjusting the threshold luminance value based on monitoring of a strain in eyes of the user using the capturing device.

8. The method of claim 4, wherein modifying the display properties of the at least part of the display comprises:
identifying one or more portions of the display corresponding to the at least one predicted region of discomfort by mapping coordinates of the real-world to the AR display using real-world-to-pixel-level scaling based on eye-position tracking of the user; and
applying a tint to the identified one or more portions of the display.

9. The method of claim 8, wherein modifying the display properties of the at least part of the display comprises:
receiving a third input related to a tint color;
selecting the tint color for applying the tint based on the received third input; and
applying the tint to the identified one or more portions of the display based on the selected tint color.

10. The method of claim 9, wherein modifying the display properties of the at least part of the display comprises:
adjusting a transparency of the identified one or more portions of the display.

11. An electronic device comprising:
memory storing instructions; and
at least one processor, comprising processing circuitry, operatively coupled to the memory,
wherein at least one processor individually and/or collectively executes the instructions to cause the electronic device to:
identify, within a Field-of-View (FOV) of the electronic device, at least one attention region and at least one non-attention region based on a real-world activity of an the user;
detect at least one distracting event in the identified at least one attention region; and
modify display properties of at least a part of a display of the electronic device based on the at least one distracting event.

12. The electronic device of claim 11, wherein at least one processor individually and/or collectively executes the instructions to cause the electronic device to:
generate a distraction map based on a head-position tracking of the user and a first input from a capturing device of the electronic device,
wherein the distraction map includes location of the at least one attention region and the at least one non-attention region in the FOV.

13. The electronic device of claim 11, wherein at least one processor individually and/or collectively executes the instructions to cause the electronic device to:
receive a second input related to the real-world activity of the user; and
identify the at least one attention region based on the received second input.

14. The electronic device of claim 11, wherein at least one processor individually and/or collectively executes the instructions to further cause the electronic device to:
detect a type of distraction and a region of distraction associated with the at least one distracting event; and
predict at least one region of discomfort impacting the real-world activity, based on at least one of the identified at least one attention region, the detected type of distraction, and the detected region of distraction.

15. The electronic device of claim 14, wherein at least one processor individually and/or collectively executes the instructions to cause the electronic device to:
track a head-position of the user;
receive the first input from the capturing device; and
generate a discomfort map based on the tracking of the head-position and the received first input from the capturing device,
wherein the distraction map includes marking for location of the at least one region of discomfort.

16. The electronic device of claim 14, wherein at least one processor individually and/or collectively executes the instructions to cause the electronic device to:
compare luminance level of the identified at least one attention region with a threshold luminance value; and
based on the comparison, identify one or more portions of the identified at least one attention region as the at least one region of discomfort.

17. The electronic device of claim 16, wherein at least one processor individually and/or collectively executes the instructions to cause the electronic device to:
set the threshold luminance value at an initial luminance value; and
adjust the threshold luminance value based on monitoring of a strain in eyes of the user using the capturing device.

18. The electronic device of claim 14, wherein at least one processor individually and/or collectively executes the instructions to cause the electronic device to:
identify one or more portions of the display corresponding to the at least one predicted region of discomfort by mapping coordinates of the real-world to the display using real-world-to-pixel-level scaling based on eye-position tracking of the user; and
apply a tint to the identified one or more portions of the display.

19. The electronic device of claim 18, wherein at least one processor individually and/or collectively executes the instructions to cause the electronic device to:
receive a third input related to a tint color;
select the tint color for applying the tint based on the received third input;
apply the tint to the identified one or more portions of the display based on the selected tint color; and
adjust a transparency of the identified one or more portions of the display.

20. A non-transitory computer-readable storage medium configured to store at least one instruction, which, when executed by at least one processor individually and/or collectively, cause the at least one processor to perform a method of claim 1.
